(19) United States
(12) Patent Application Publication
(10) Pub. No.: US 2010/0314507 A1
(43) Pub. Date: Dec. 16, 2010

(54) Adjustable Bag Retaining Apparatus

(76) Inventors: Toni Laitila, Peterborough (CA); Andy Laitila, Peterborough (CA); Mika Laitila, Peterborough (CA)

Correspondence Address: SUZANNAH K. SUNDBY;SMITH, GAMBRELL & RUSSEL, LLP, 1130 Connecticut Avenue, NW, Suite 1130, WASHINGTON, DC, 20036, US

(21) Appl. No.: 12/483,170

(22) Filed: Jun. 11, 2009

(51) Int. Cl. F16M 13/00

(52) U.S. Cl. 248/97; 248/95

(57) ABSTRACT

Provided is an adjustable bag retaining apparatus comprising a hook or clamp, the hook or clamp capable vertically sliding movement on or in a track, mast, stand, support or hollow sleeve for accomodating bags of different sizes for packing.

### FIELD OF INVENTION

The present invention relates to an apparatus that holds bags. More specifically, the present invention relates to an adjustable apparatus that holds bags of different sizes.

### BACKGROUND OF THE INVENTION

Over the last few years there has been a growing trend in the grocery industry and other retailers to encourage the use of reusable bags, while discouraging the use of plastic. This is happening worldwide but especially North America where use of traditional plastic bags is still prominent. Various jurisdictions such as San Francisco and Toronto have already banned or imposed a tax on traditional single use plastic bags and this trend is increasing.

The trend to reuse old grocery bags or more environmentally friendly reusable shopping bags such as long lasting cotton, canvas or durable reusable plastic shopping bags is generally well accepted by consumers. However, most bags that customers bring in to the stores come in various sizes and styles. Cashiers are currently having difficulty bagging groceries and other items into these bags of various shapes and sizes. A major problem is that the bags do not sit properly or stay open very well during bagging. This makes the bagging process inefficient for cashiers thereby increasing waiting times for customers. Because of these drawbacks, some supermarkets are replacing their checkouts to scan and pass models where the cashier scans the product and passes it back for bagging by the customer or an assistant bagger. This results in low customer service where customers bag themselves or high costs in the cases where rear baggers are employed. Stores that want to retain cashier bagging service need an easier way of bagging items into the reusable bags of various shapes and sizes.

There is a need in the art for novel bag holders. There is also a need in the art for adjustable bag holders that can accommodate a wide range of reusable bag types and sizes while also accommodating existing single use plastic bags known in the industry as “T-shirt” plastic bags and “Wave-top” plastic bags.

### SUMMARY OF THE INVENTION

The present invention relates to an apparatus that holds bags. More specifically, the present invention relates to an adjustable apparatus that holds bags of different sizes.

According to an embodiment of the present invention, there is provided an adjustable bag retaining apparatus comprising,

a) a clamp member,

b) a hollow sleeve,

c) a sleeve engaging member attached to the clamp member at one end thereof, the sleeve engaging member capable of vertically sliding movement within the sleeve, and;

d) optionally, either
i) a plurality of flanges attached to the sleeve and extending outwardly therefrom, said flanges optionally comprising one or more apertures for fixedly attaching the adjustable bag retaining apparatus to a surface or substrate, or
ii) a plurality of protrusions, optionally threaded such as, but not limited to studs, screws, machine screws, or bolts attached to the sleeve and extending outwardly therefrom for fixedly attaching the adjustable bag retaining apparatus to a vertical surface or substrate.

The present invention also provides an adjustable bag retaining apparatus comprising,

a) a clamp member,

b) a hollow sleeve,

c) a sleeve engaging member attached to the clamp member at one end thereof, the sleeve engaging member capable of vertically sliding movement within the sleeve, and;

d) a base member attached to the sleeve, the base member optionally comprising one or more apertures for fixedly attaching the adjustable bag retaining apparatus to a surface or substrate.

The present invention further provides an adjustable bag retaining apparatus as described above further comprising a structural support frame.

The present invention further provides an adjustable bag retaining apparatus as described above, wherein the base member is substantially square or rectangular and has one or more apertures for affixing the adjustable bag retaining apparatus to a surface.

The present invention further provides an adjustable bag retaining apparatus as described above wherein the base member is made of steel or metal or plastic.

The present invention further provides an adjustable bag retaining apparatus as described above wherein base member is welded to the structural support frame.

The present invention further provides an adjustable bag retaining apparatus as described above wherein the base member is affixed on top of a loop extension of the structural support frame at the periphery of the base member.

The present invention further provides an adjustable bag retaining apparatus as described above, wherein the structural support frame comprises one or more cross braces along its width and/or length to provide rigidity thereto and provide height adjustment capabilities when used with existing checkout counter infrastructure such as, but not limited to linear metal hooks attached to the vertical surface of a bagwell.

The present invention further provides an adjustable bag retaining apparatus as described above, wherein the structural support frame comprises two proximal frame piece members affixed to the base member on an upper portion of the plane thereof and extending about vertically therefrom, and two distal frame piece members affixed to the base member on an under portion of the plane thereof and extending about vertically therefrom.

The present invention further provides an adjustable bag retaining apparatus as described above, wherein the two distal frame piece members affixed to the base member on an under portion of the plane thereof and extending about vertically therefrom form a continuous loop under the base member.

The present invention further provides an adjustable bag retaining apparatus as described above, wherein a hook member is affixed to the structural support frame used for holding the tab found at the top center of T-shirt plastic bags.

The present invention further provides an adjustable bag retaining apparatus as described above, wherein the clamp member slides vertically and stays in position under frictional engagement within the sleeve.

The present invention further provides an adjustable bag retaining apparatus as described above, wherein the clamp member is attached at the distal end of a sleeve engaging member for sliding vertically within the sleeve.

The present invention further provides an adjustable bag retaining apparatus as described above, wherein the sleeve comprises one or more protrusions extending into the cavity of the sleeve, and said sleeve engaging member comprises one or more stopping members to abut said one or more protrusions on said sleeve to prevent removal or disassembly of the sleeve engaging member from said sleeve.

The present invention further provides an adjustable bag retaining apparatus as described above, wherein the clamp member comprises a torsion spring that biases the clamp member to a closed or clamping position.

The present invention further provides an adjustable bag retaining apparatus as described above, further comprising at least two extension members positioned about opposite sides of the support frame and extending outwardly therefrom and generally parallel to the base member and comprise a terminal end portion that curves upward away from the base member.

The present invention further provides an adjustable bag retaining apparatus as described above, further comprising at least two extension members positioned about opposite sides of the support frame and extending outwardly therefrom generally parallel to the base member and forming a closed loop.

The present invention also provides an adjustable bag retaining apparatus as described in any of FIGS. 1-22 or any combination of features shown therein.

The present invention also provides an adjustable bag retaining apparatus as described above, further comprising one or more bags.

The present invention also contemplates a bag retaining apparatus comprising any combination of features of the bag retaining apparatus described above with the exception that the clamp member is replaced with a hook member and the hook member is capable of vertically sliding movement and can accomodate the handles of bags of various sizes.

The present invention also contemplates an adjustable bag retaining apparatus comprising a clamp member or hook member, the clamp or hook member capable of being adjusted to a desired vertical height on a stand or support by a height adjustment means.

This summary of the invention does not necessarily describe all features of the invention.

### BRIEF DESCRIPTION OF THE DRAWINGS

These and other features of the invention will become more apparent from the following description in which reference is made to the appended drawings wherein:

FIG. 1 shows a representative depiction of the adjustable bag retaining apparatus.

FIG. 2 shows a representative depiction of the adjustable bag retaining apparatus.

FIG. 3 shows a representative depiction of the adjustable bag retaining apparatus further comprising a base member and structural support frame.

FIG. 4 shows a representative depiction of the adjustable bag retaining apparatus further comprising a base member, structural support frame, hook and two or more extension members.

FIG. 5 shows a representative depiction of the adjustable bag retaining apparatus similar to FIG. 4 but with the clamp member vertically extended.

FIG. 6 shows a representative depiction of the adjustable bag retaining apparatus.

FIG. 7 shows a representative front view depiction of the adjustable bag retaining apparatus.

FIG. 8 shows a representative rear view depiction of the adjustable bag retaining apparatus.

FIG. 9 shows a representative overhead view depiction of the adjustable bag retaining apparatus.

FIG. 10 shows a representative side view depiction of the adjustable bag retaining apparatus.

FIG. 11 shows a representative depiction of the adjustable bag retaining apparatus holding a small reusable bag.

FIG. 12 shows a representative depiction of the adjustable bag retaining apparatus holding a larger reusable bag than in FIG. 11.

FIG. 13 shows a representative depiction of a clamp member that may be employed in the adjustable bag retaining apparatus.

FIG. 14 shows a representative depiction of a clamp member that may be employed in the adjustable bag retaining apparatus.

FIG. 15 shows a representative depiction of a clamp member that may be employed in the adjustable bag retaining apparatus.

FIG. 16 shows a representative depiction of the adjustable bag retaining apparatus.

FIG. 17 shows a representative depiction of the adjustable bag retaining apparatus.

FIG. 18 shows a representative depiction of the adjustable bag retaining apparatus.

FIG. 19 shows a partial representative depiction of the adjustable bag retaining apparatus.

FIG. 20 shows a representative depiction of the adjustable bag retaining apparatus holding the handle of a bag.

FIG. 21 shows an alternate representative depiction of the adjustable bag retaining apparatus holding the handle of a bag.

FIG. 22 shows a representative depiction of the adjustable bag retaining apparatus showing a hook member replacing a clamp member, the hook member capable of telescopic movement for vertical adjustability.

### DETAILED DESCRIPTION

The following description is of a preferred embodiment.

According to the present invention there is provided an adjustable bag retaining apparatus (10) comprising,

a) a clamp member (20),

b) a hollow sleeve (30),

c) a sleeve engaging member attached to the clamp member at one end thereof, the sleeve engaging member capable of vertically sliding movement within the sleeve, and;

d) optionally, either
i) a plurality of flanges attached to the sleeve and extending outwardly therefrom, said flanges optionally comprising one or more apertures for fixedly attaching the adjustable bag retaining apparatus to a surface or substrate, or
ii) a plurality of protrusions, optionally threaded, such as, but not limited to studs, screws, machine screws, or bolts attached to the sleeve and extending outwardly therefrom for fixedly attaching the adjustable bag retaining apparatus to a surface or substrate.

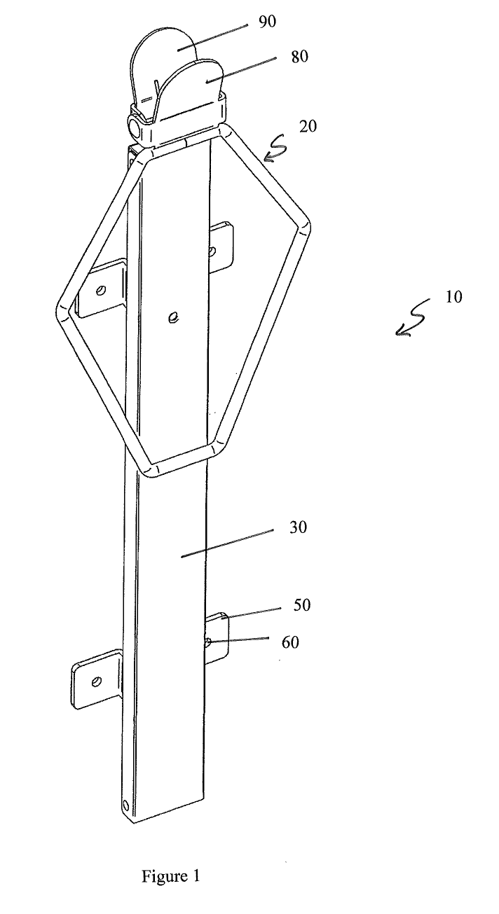

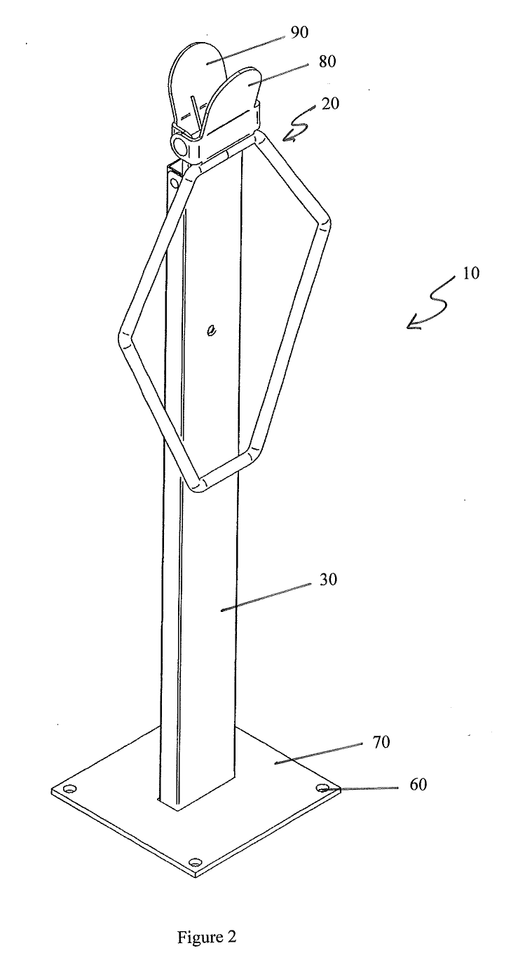

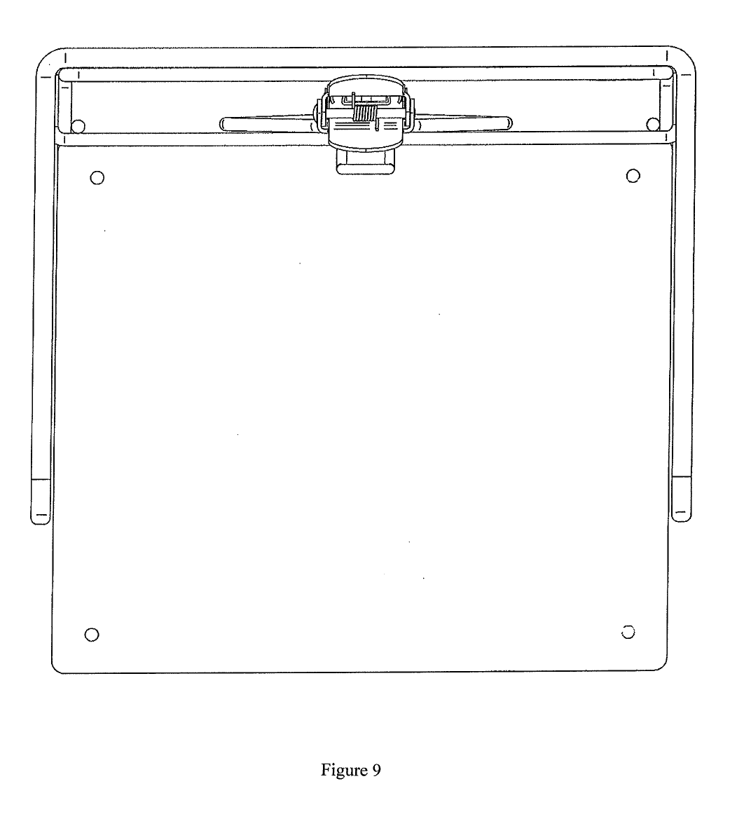

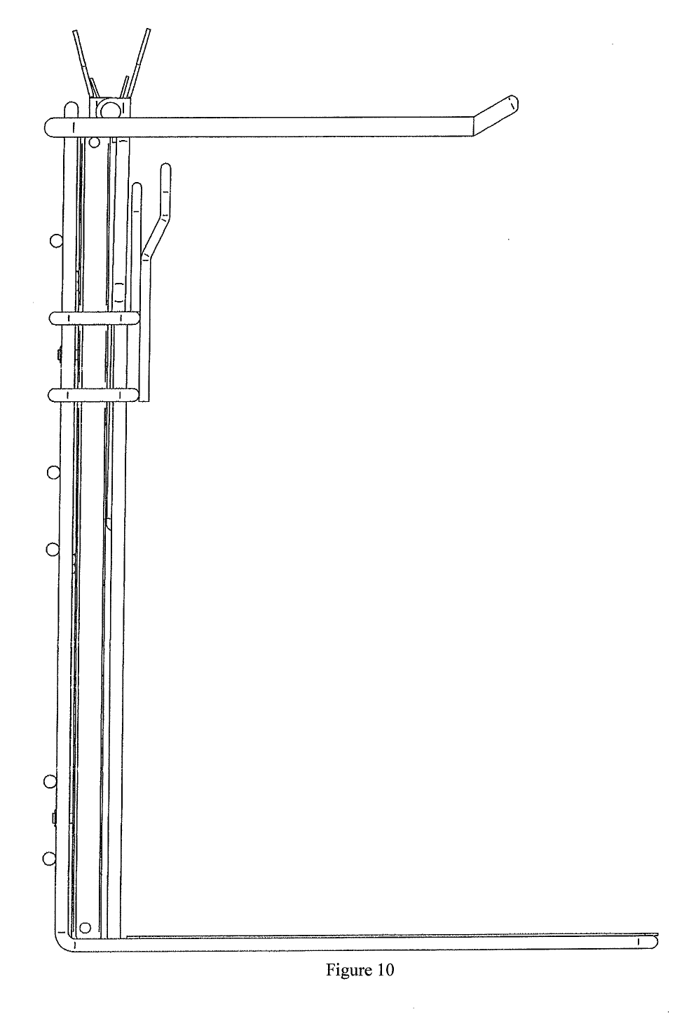

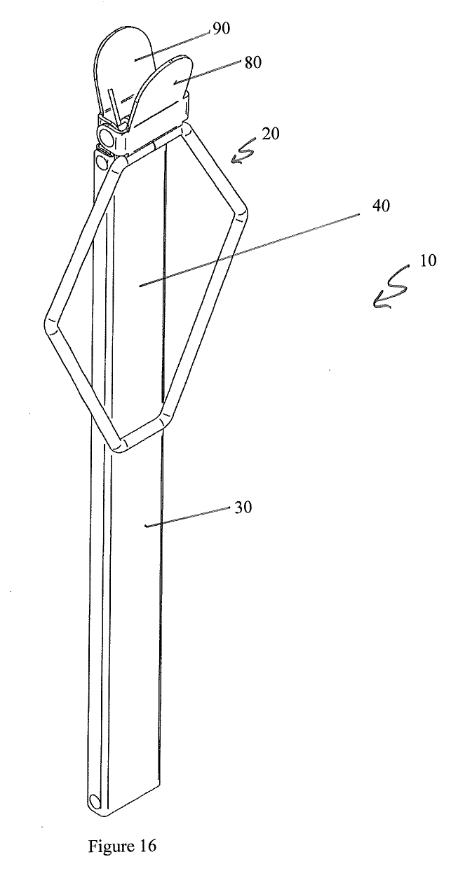

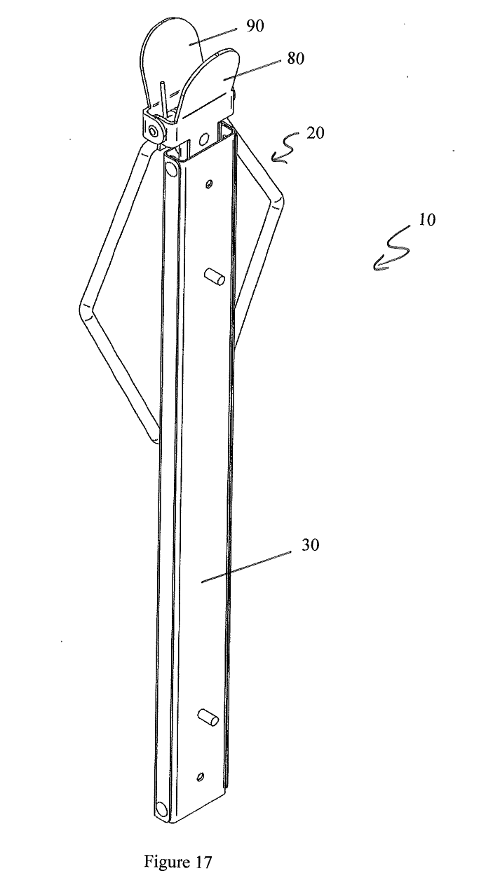

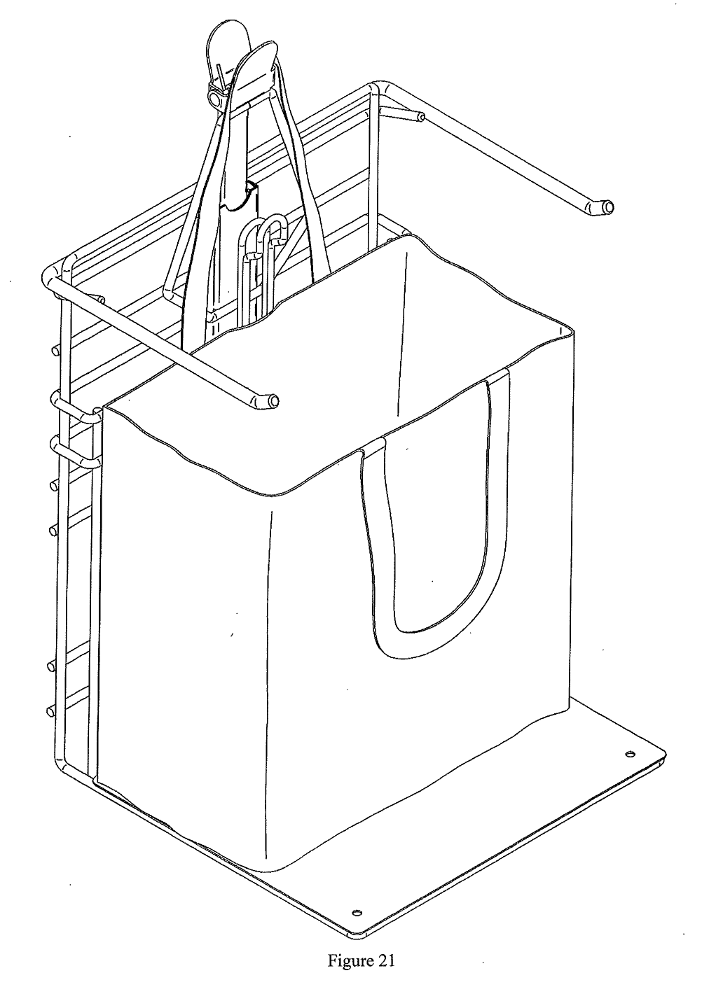

FIG. 1 shows a representative embodiment of the present invention, which is not meant to be limiting in any manner. FIGS. 2-22 show alternate embodiments, which are not meant to be limiting in any manner.

In the embodiment wherein the bag clamping apparatus is affixed to a surface or substrate, the vertical (up/down) movement of the clamp member permits the bag clamping apparatus to accommodate bags of different heights and avoids the problem of having to squish a tall bag underneath a fixed-height clamp, hook or clip.

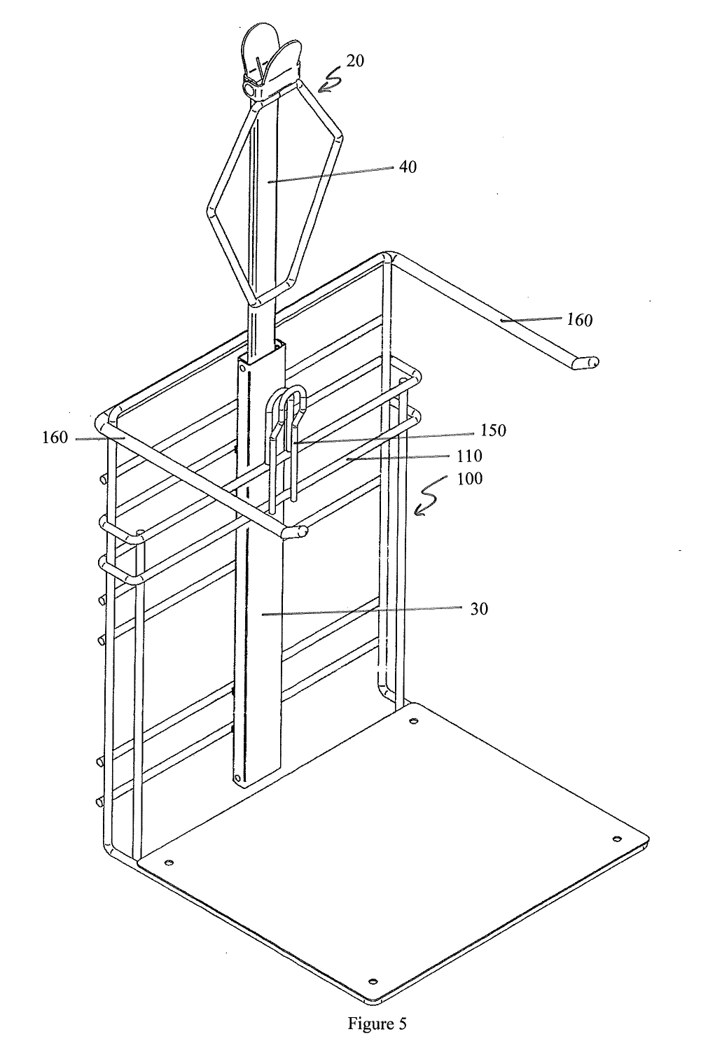

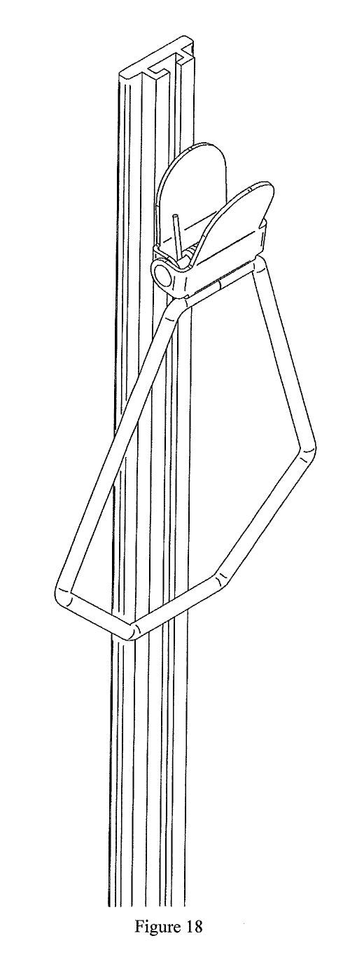

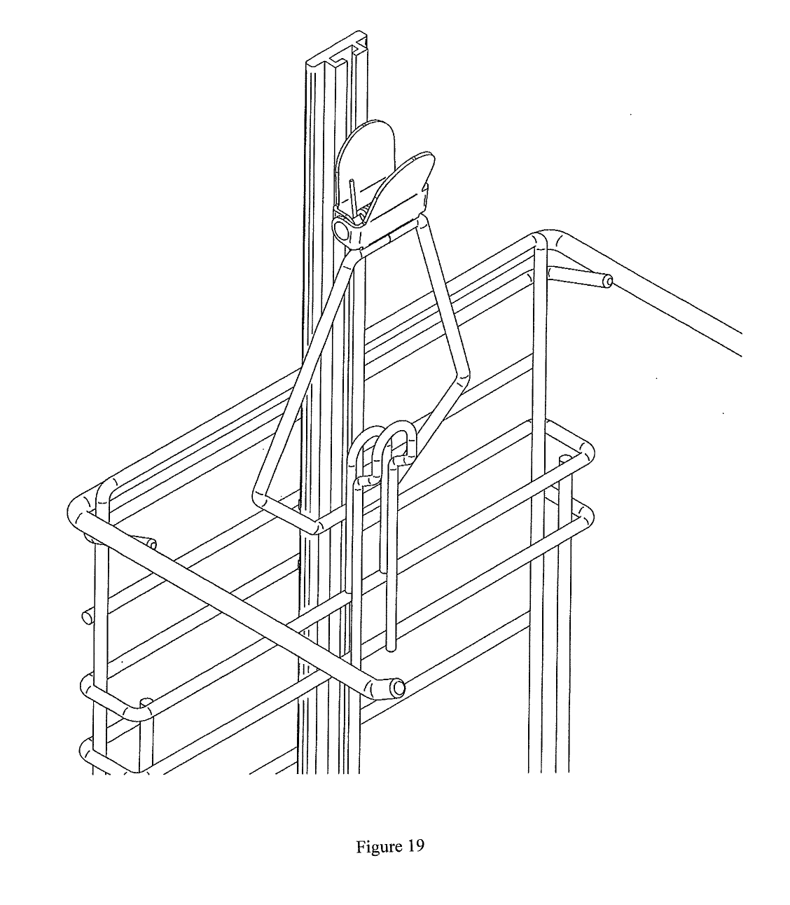

The sleeve of the bag clamping apparatus may comprise one or more protrusions extending into the cavity thereof, and the sleeve engaging member may comprise one or more stopping members, bosses or the like that abut the one or more protrusions preventing removal or disassembly of the sleeve engaging member from the sleeve. It is also contemplated that the height positioning of the clamp member may be provided by frictional engagement of the sleeve engaging member with the sleeve or another component therein. Alternatively, it is also contemplated that the sleeve engaging member may engage one or more positive stops thereby regulating the extension of the clamp member at specific heights. Such methods for regulating the vertical extension/height of slidably related components are known in the art and any such method may be employed herein. For example, but not wishing to be limiting in any manner, the sleeve engaging member and sleeve may form a ball-bearing drawer slide as is known in the art. Alternatively, the up/down movement of the clamp member may be provided, for example, by telescoping (for example, but not limited to, as shown in FIG. 5) or sliding (for example, but not limited to, as shown in FIGS. 18 and 19) metal or nonmetal tubes or poles, channels, aluminum, metal or plastic extrusions, drawer slides, or the like. Regulating the height positioning of the clamp member may be accomplished by any height adjustment means known in the art. In an embodiment which is not meant to be limiting in any manner, the height adjustment means comprises one or more protrusions or slots in the track, mast, stand or sleeve that engages the clamp member or hook member or a component that connects to the clamp or hook member and retains it at a desired height for engaging the handles of a reusable bag.

The clamp member preferably comprises a torsion spring that biases the clamp member to a closed or clamping position. Applying a squeezing force to a first protruding surface (80) and a second protruding surface (90) extending from the clamp may be used to overcome the torsion force provided by the spring. Any other method of exerting a clamping force may be employed in the clamp as described herein.

The clamping member may comprise any shape for clamping a bag. It is preferred that the clamping member comprise generally a diamond shape portion, but any suitably-shaped clamping member, for example, triangular, square, rectangular, circular, oval, etc, for holding bags in an open position may be used. In an embodiment which is not meant to be limiting, the clamping member comprises generally a cylindrical wire or bar in the shape of a diamond.

The sleeve and sleeve engaging member may also comprise any suitable shape, for example, but not limited to rectangular prism, cylinder, elliptoid or the like. However, it is generally preferred that the sleeve is a rectangular prism as the flat surface generally permits the bag clamping apparatus to be more easily affixed to a surface or substrate.

According to a further embodiment of the present invention, there is provided an adjustable bag retaining apparatus (10) comprising,

a) a clamp member (20),

b) a hollow sleeve (30),

c) a sleeve engaging member attached to the clamp member at one end thereof, the sleeve engaging member capable of vertically sliding movement within the sleeve, and;

d) a base member (70) attached to the sleeve, the base member optionally comprising one or more apertures (60) for fixedly attaching the adjustable bag retaining apparatus (10) to a surface or substrate.

An embodiment of the present invention, which is not meant to be limiting in any manner is shown in FIG. 2.

In an embodiment wherein the adjustable bagging apparatus comprises a base member, it is preferable that the base member is substantially square or rectangular, but any suitable shape is contemplated herein. Also, the base member may be made of any suitable material, but metal or steel is preferred due to its strength. The sleeve may be attached to the base member by any way known in the art, for example, but not limited to welding, screws, rivets, pins and the like. In this regard, it is generally preferred that that the base member is made from the same material as the sleeve and the sleeve is centered thereon for structural support and to prevent the adjustable bag retaining apparatus from falling over when placed upright. However, for increased structural support, a structural support frame may be employed as described below.

The present invention also contemplates that the adjustable bag retaining apparatus may further comprise a structural support frame (100). The structural support frame provides structural rigidity when the bag clamping apparatus is used and may also permit the bag clamping apparatus to be more easily affixed to a surface or substrate.

In an embodiment of the present invention, the structural support frame (100) is generally rectangular in structure with a plurality of cross braces (110) traversing the structure in width and optionally length. However, any shape or structure that provides enhanced structural support for the bag clamping member is contemplated. Further, the cross braces may be overlapping, or integral throughout the structural support frame. Also, it is contemplated that the support frame may comprise one or more metal rods, beams or the like. In a preferred embodiment, the cross braces (110), for example, but not limited to metal rods are affixed to the distal frame piece members (120), preferably welded thereto. In addition to structural rigidity, the cross braces provide height adjustment capabilities when used with existing checkout counter infrastructure such as linear metal hooks attached to the vertical surface of a bagwell.

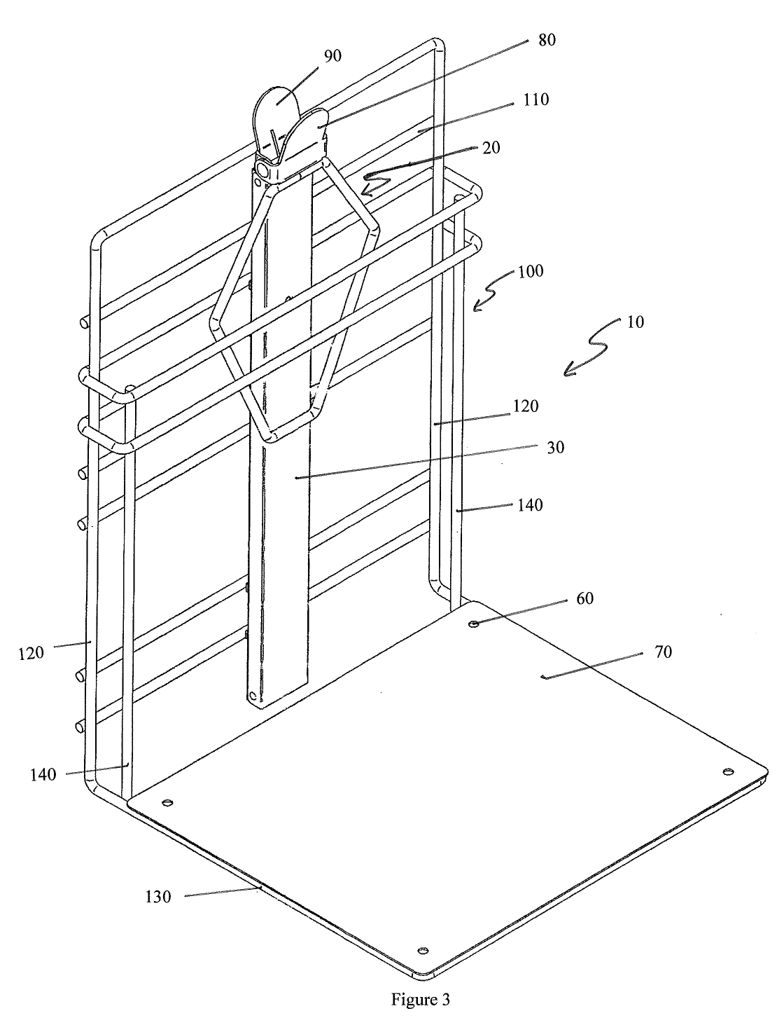

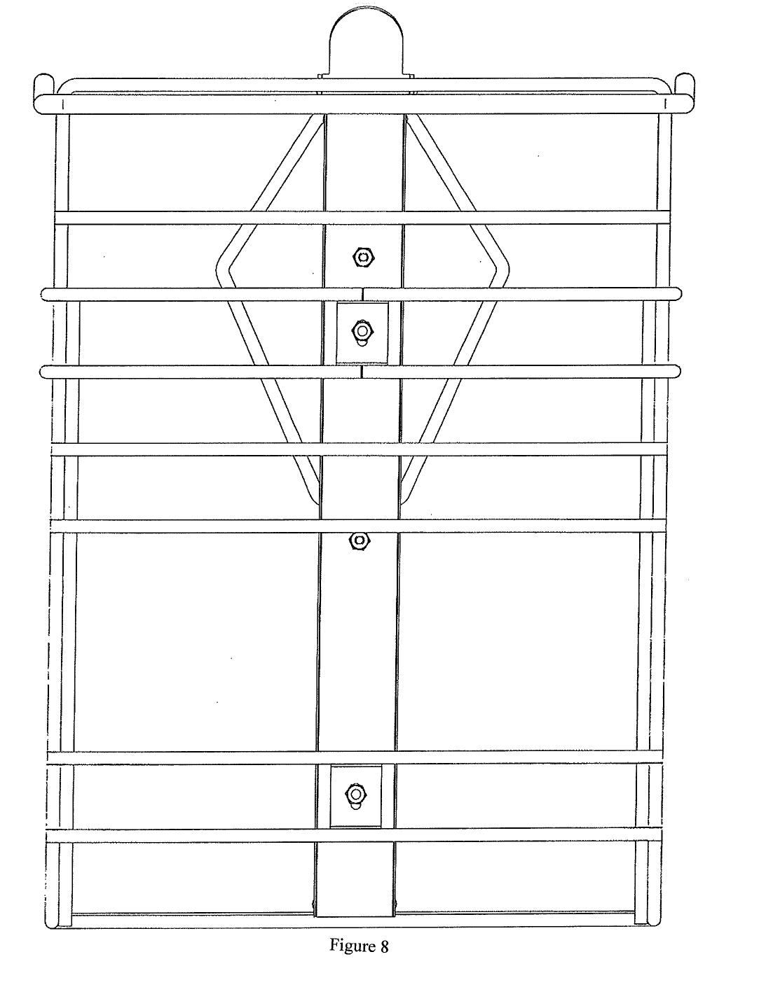

The sleeve (30) may be attached to the structural support frame (100) by any means as would be known in the art, for example, but not limited to, by welding, studs, bolts, screws, machine screws, a bracket or any combination thereof However, it is generally preferred that the sleeve is attached at about the midpoint of the frame. This is shown in FIG. 3 and FIG. 8.

The present invention also contemplates that the sleeve may be attached to the structural support frame between two or more sets of cross braces that extend therefrom, generally in two different but parallel planes with the overall plane of the support frame. This is also shown in FIG. 3 and FIG. 8.

It is also contemplated that either the sleeve, structural support frame or both may be attached to a base member. This is shown in FIG. 3. In embodiments wherein the bag clamping apparatus comprises a base member, it is preferable that the base member is substantially square or rectangular, but again any suitable shape is contemplated herein. Also, the base member may be made of any suitable material, but metal or steel is preferred due to its strength. In this regard, it is generally preferred that that the base member is made from the same material as the structural support frame. In embodiments wherein the base member and support frame are made of metal, they may be welded together or attached by any other method or means as known in the art. However, welding is preferred. The base member may also comprise one or more apertures or holes to assist in affixing the apparatus to a support surface.

In a further embodiment, which is not meant to be limiting in any manner, it is also contemplated that the base member is affixed on top of a loop extension (130) of the structural support frame (100) at the periphery of the base member.

The present invention also provides a structural support frame (100) comprising two proximal frame piece members (140) affixed to the base member (70) on an upper portion of the plane thereof and extending about vertically therefrom, and two distal frame piece members (120) affixed to the base member on an under portion of the plane thereof and extending about vertically therefrom. However, both the proximal and distal frame members may be attached to the base in other ways. Further, it is contemplated that both the proximal and distal frame members are attached only to the structural support frame. Also, but less preferred, the structural support frame may comprise only two frame piece members providing two of the outer perimeter sides of the structural support frame.

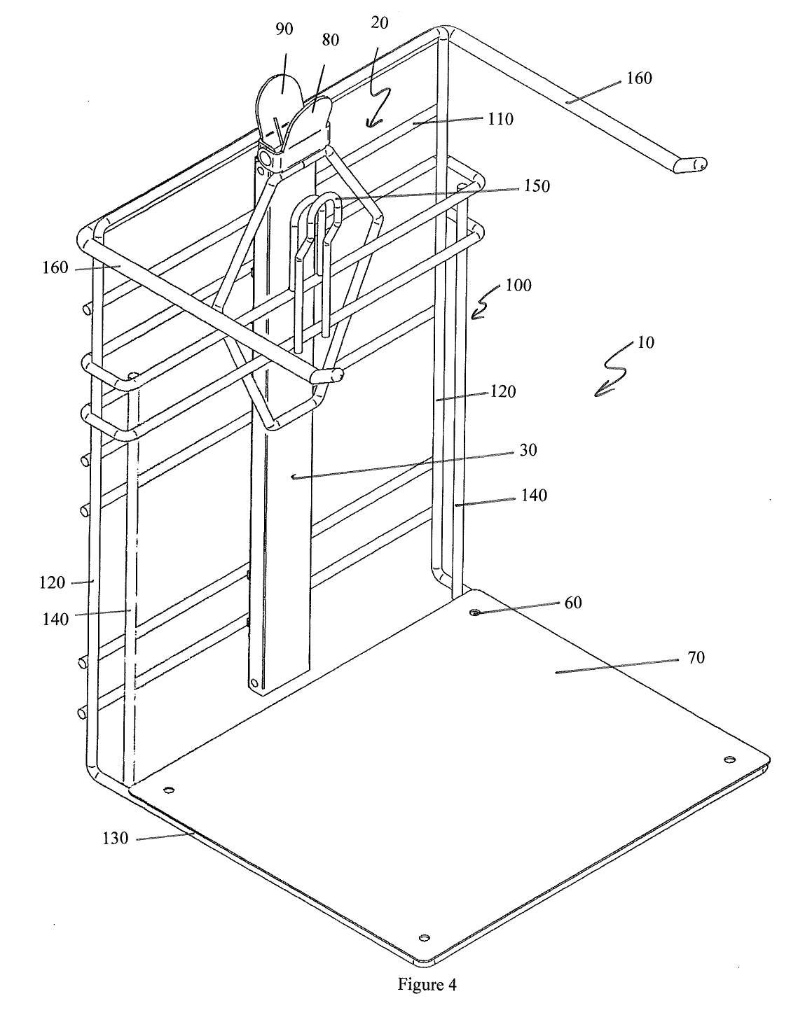

Optionally, the support frame may comprise a hook member (150), attached to the structural support frame or integral therewith at about the centre-portion or midpoint of the frame. In the embodiment shown in FIG. 4, the hook member (150) is positioned at about the midpoint of the structural support frame (100) in front of the sleeve (30) on a plurality of cross brace members (110). This allows the clamping member (120) to be positioned in a slot created by the cross brace members that attach and/or form the hook and the other cross brace members forming part of the structural support frame. The sliding clamp member can thereby be positioned out of the way when bagging into traditional t-shirt plastic bags which include a tab located at the top center of the bag and are held by the hook member (150). FIG. 5 is similar to FIG. 4, but shows the clamp member (20) extended vertically from the sleeve (30) and exposing a portion of the sleeve engaging member (40).

The present invention also contemplates a bag clamping apparatus that further comprises a plurality of extension members (160) or arms extending from the frame. The extension members are shown, for example, in FIG. 4. This is particularly preferred if the bag clamping apparatus is employed in a grocery store or the like that continues to bag into traditional plastic bags known as t-shirt plastic bags.

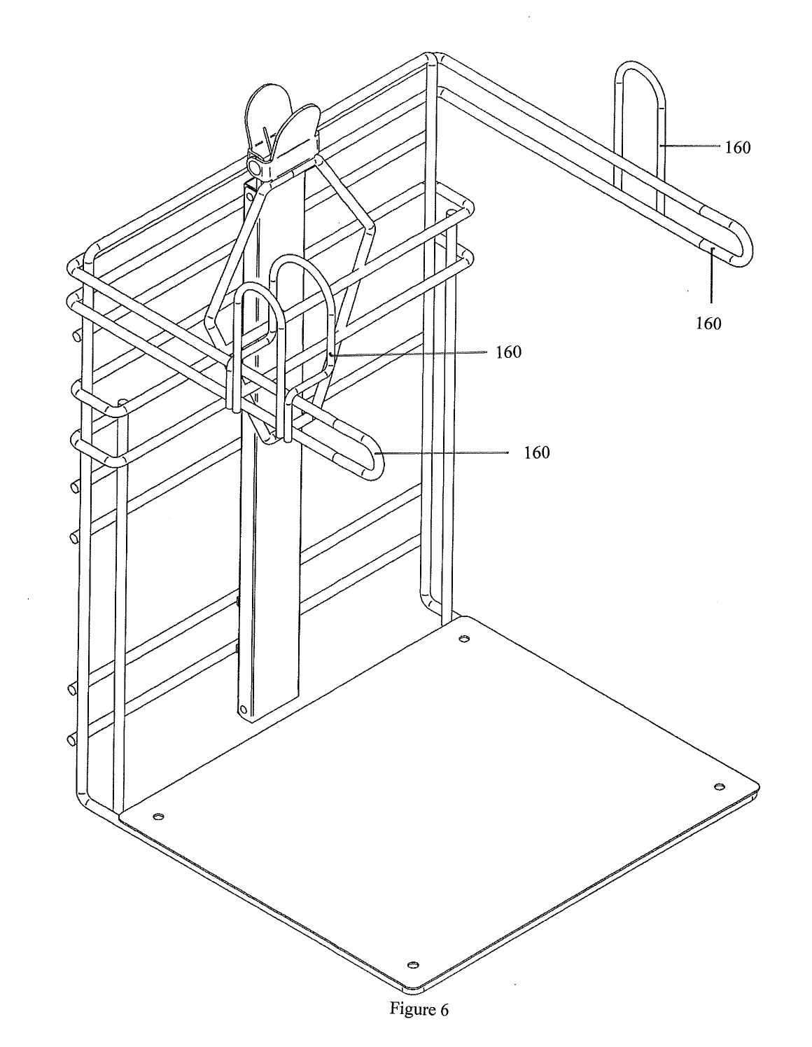

As a representative example, at least two or more than two extension members or arms may protrude from the structural support frame. Preferably, they are positioned about opposite sides of the support frame and extend outwardly therefrom generally parallel to the base member if one is employed. It is also contemplated that the terminal end portions may curve upward (as shown, for example, in FIG. 4), (accommodating T-shirt plastic bags), away from the base member (if employed) or the extension members (160) may form loops of various sizes or dimensions and optionally protrude in one or more directions from the frame, for example, but not limited to as shown in FIG. 6, which accommodates wave-top plastic bags.

In a further embodiment, which is not meant to be limiting in any manner, it is contemplated that each extension member may be foldable, for example, but not limited to, folding horizontally toward the middle of the adjustable bag retaining apparatus. In a more preferred embodiment, the extension member(s) fold down, and thus do not interfere with the clamp member.

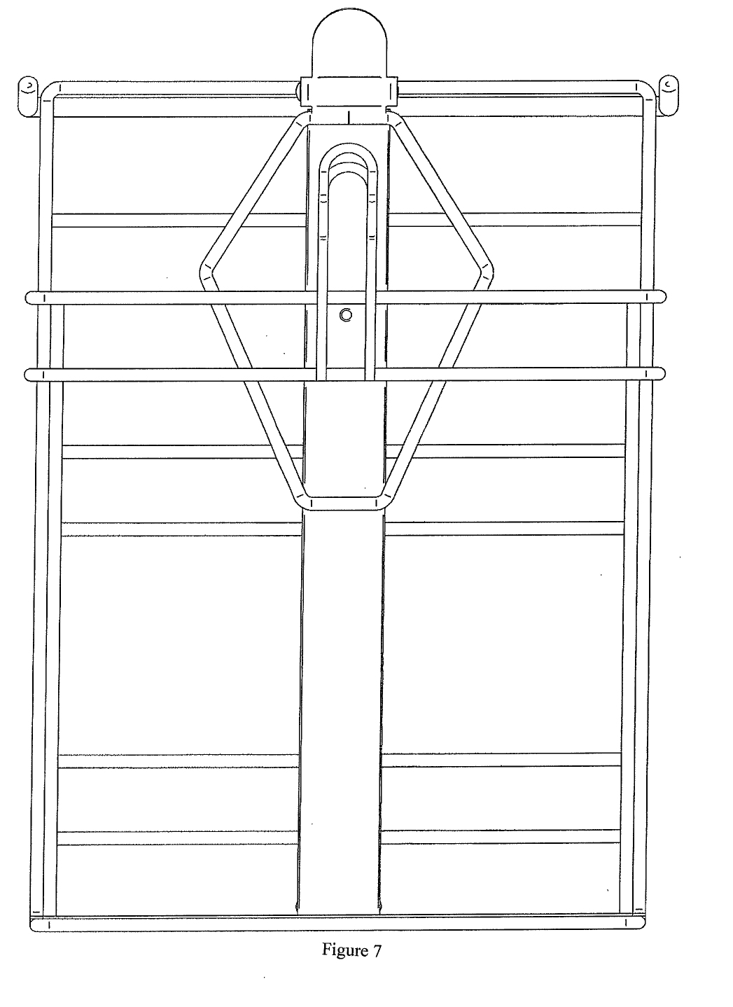

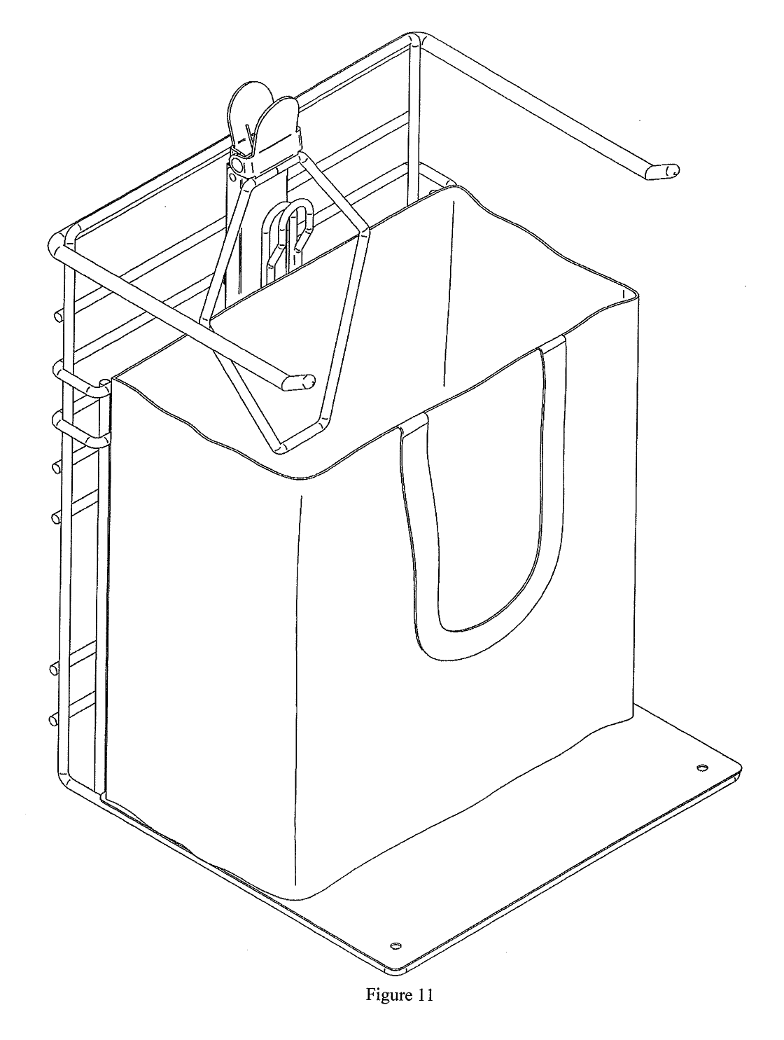

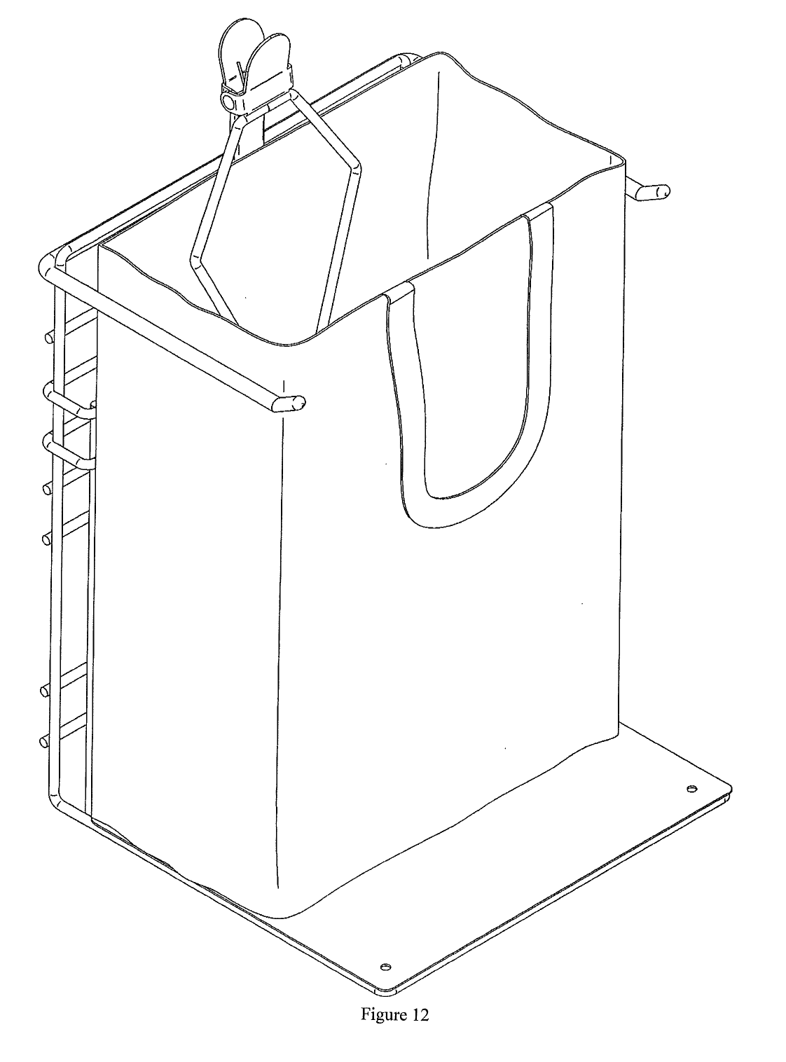

FIGS. 7-10 are front, rear, top and side views, respectively of representative depictions, which are not meant to be limiting in any manner, of the adjustable bag retaining apparatus as described herein. FIGS. 11-12 show representative embodiments, which are not meant to be limiting in any manner of an adjustable bag holding apparatus holding a small reusable bag and a larger reusable bag, respectively.

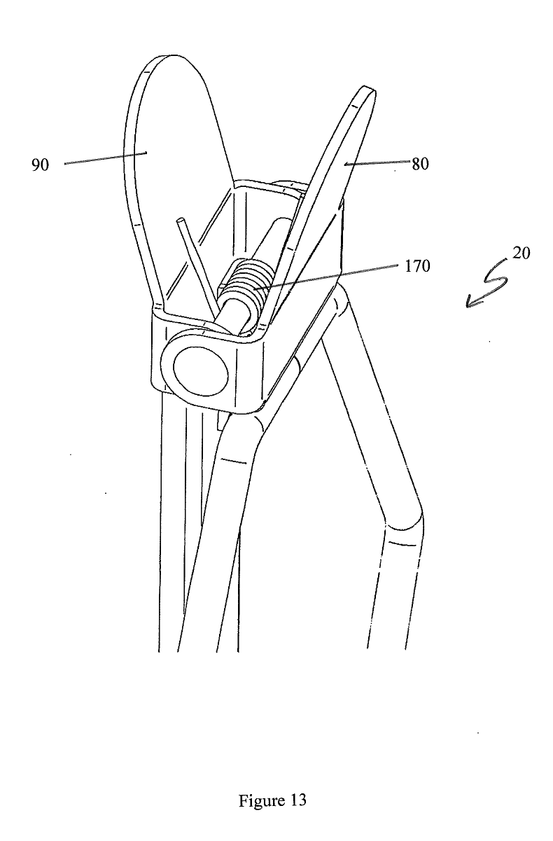

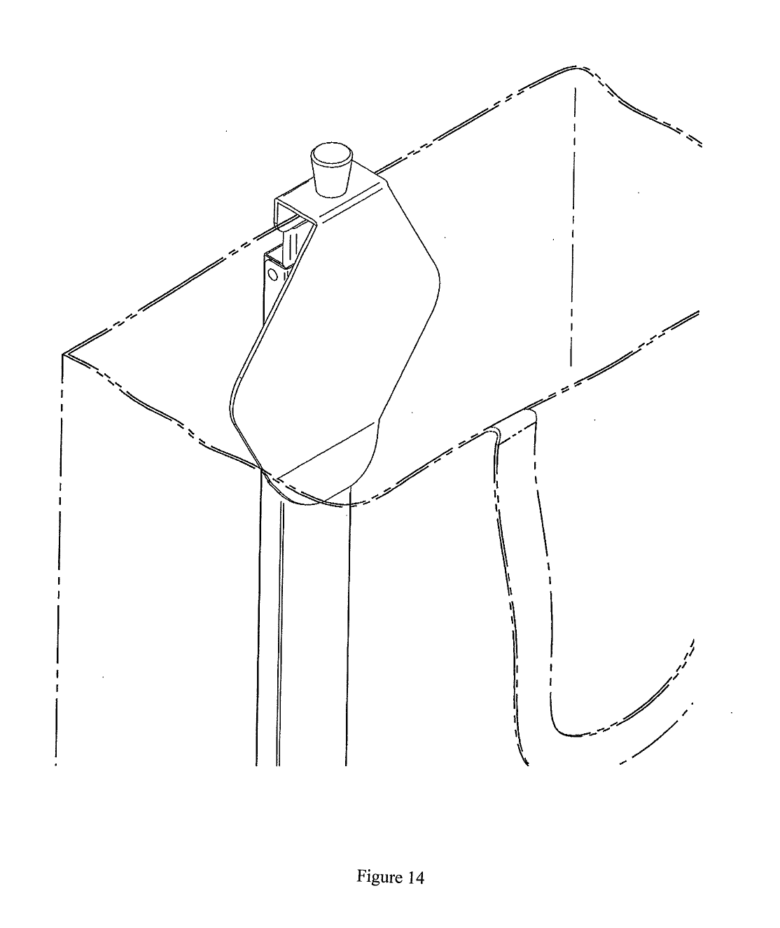

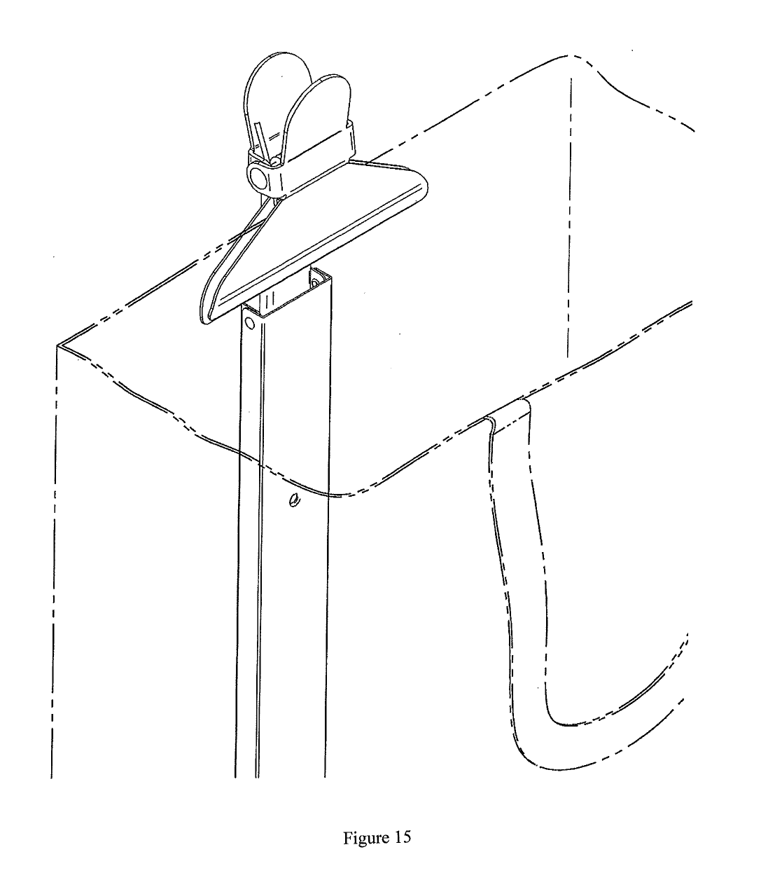

FIG. 13 shows an expanded view of a non-limiting, representative clamp member (20) comprising first protruding surface (80) and second protruding surface (90) and also showing torsion spring (170). Other clamp members as known in the art also may be employed in the adjustable bag retaining apparatus of the present invention, for example, but not limited to, as shown in FIGS. 14 and 15.

The adjustable bag retaining apparatus as described herein may stand freely on or be attached to any suitable surface, preferably a horizontal flat surface such as a checkout counter bagwell. Alternatively, the adjustable bag retaining apparatus may be mounted onto a vertical sidewall of a checkout, mounted into a t-shirt or wave-top wire bag rack for plastic bags, attached to a vertical or horizontal pull-out board or on a hinged/ cantilevered arm or the like.

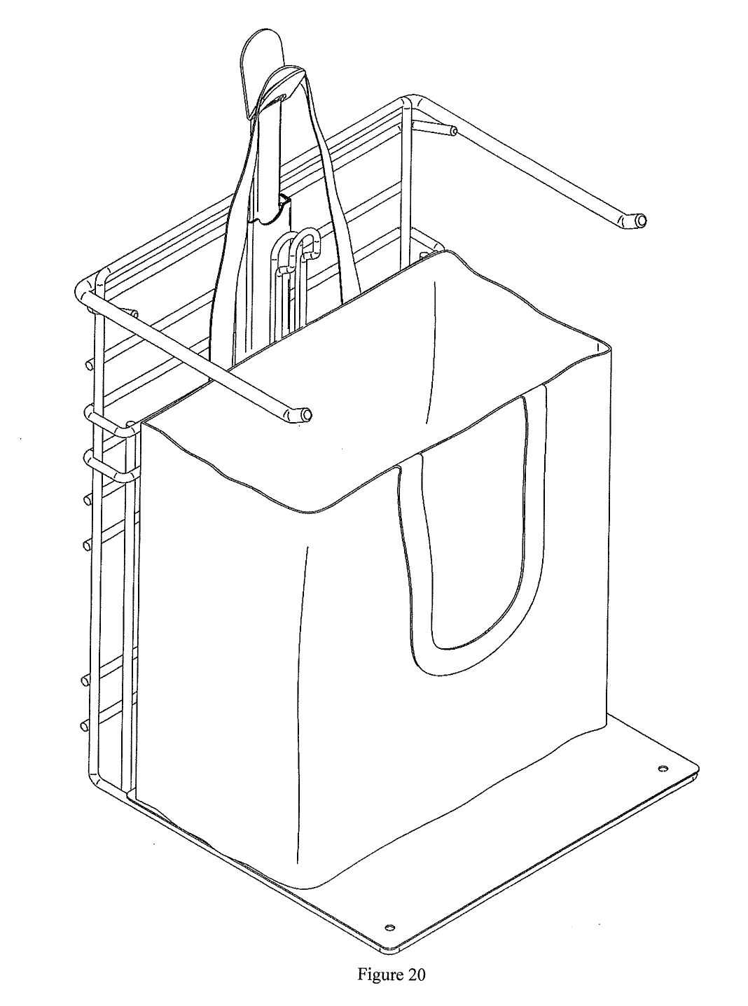

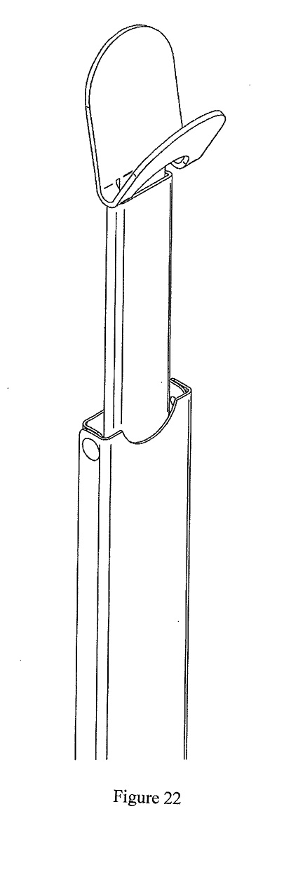

In still another embodiment of the present invention there is provided an adjustable bag holding apparatus comprising any combination of features of the adjustable bag retaining apparatus as described above with the exception that the clamp member is replaced by a hook member and the sleeve member is attached to the hook member and is capable of vertically sliding movement. Such an embodiment, which is not meant to be limiting is shown in FIGS. 20 and 22.

In yet a further embodiment, which is not meant to be limiting in any manner, there is provided an adjustable bag retaining apparatus comprising a clamp member or hook member, the clamp or hook member capable of being adjusted to a desired vertical height on a fixed length stand, track, mast or support by a height adjustment means. The height adjustment means may comprise any height adjustment means as described herein or as is known in the art. For example, but not wishing to be limiting the clamp or hook may frictionally engage and slide up and down a stand, track, mast, support or the like and thus be retained at a desired vertical height. Alternatively, the clamp, or hook may be secured to a stand, support or the like, for example, but not limited to by a screw, pin, cotter-pin, a second clamp or any combination thereof. Any height adjustment means known in the art may be employed to secure the clamp or hook at a desired vertical height.

It is also contemplated that fixed length stand, track, mast or support may be formed from an extrusion, for example, but not limited to an aluminum extrusion. However, other materials or combinations of materials are also contemplated as would be known in the art.

The present invention has been described with regard to one or more embodiments. However, it will be apparent to persons skilled in the art that a number of variations and modifications can be made without departing from the scope of the invention as defined in the claims.

What is claimed is:

1. An adjustable bag retaining apparatus comprising,
a) a clamp member,
b) a hollow sleeve,
c) a sleeve engaging member attached to the clamp member at one end thereof, the sleeve engaging member capable of vertically sliding movement within the sleeve, and;
d) optionally either
i) a plurality of flanges attached to the sleeve and extending outwardly therefrom, said flanges optionally comprising one or more apertures for fixedly attaching the adjustable bag retaining apparatus to a surface or substrate, or
ii) a plurality of protrusions, said protrusion being optionally threaded and attached to the sleeve and extending outwardly therefrom for fixedly attaching the adjustable bag retaining apparatus to a surface or substrate.

2. An adjustable bag retaining apparatus comprising,
a) a clamp member,
b) a hollow sleeve,
c) a sleeve engaging member attached to the clamp member at one end thereof, the sleeve engaging member capable of vertically sliding movement within the sleeve, and;
d) a base member attached to the sleeve, the base member optionally comprising one or more apertures for fixedly attaching the adjustable bag retaining apparatus to a surface or substrate.

3. The adjustable bag retaining apparatus of claim 1, further comprising a structural support frame.

4. The adjustable bag retaining apparatus of claim 2, further comprising a structural support frame.

5. The adjustable bag retaining apparatus of claim 2, wherein the base member is substantially square or rectangular and has one or more apertures for affixing the adjustable bag retaining apparatus to a surface.

6. The adjustable bag retaining apparatus of claim 2 wherein the base member is made of steel or metal.

7. The adjustable bag retaining apparatus of claim 4, wherein base member is welded to the structural support frame.

8. The adjustable bag retaining apparatus of claim 4, wherein the base member is affixed on top of a loop extension of the structural support frame at the periphery of the base member.

9. The adjustable bag retaining apparatus of claim 3, wherein the structural support frame comprises one or more cross braces along its width and/or length to provide rigidity thereto, and height adjustment capabilities with existing checkout counter infrastructure.

10. The adjustable bag retaining apparatus of claim 4, wherein the structural support frame comprises two proximal frame piece members affixed to the base member on an upper portion of the plane thereof and extending about vertically therefrom, and two distal frame piece members affixed to the base member on an under portion of the plane thereof and extending about vertically therefrom.

11. The adjustable bag retaining apparatus of claim 10, wherein the two distal frame piece members affixed to the base member on an under portion of the plane thereof and extending about vertically therefrom form a continuous loop under the base member.

12. The adjustable bag retaining apparatus of claim 4, wherein a hook member is affixed to the structural support frame used for holding the tab found at the top center of T-shirt plastic bags.

13. The adjustable bag retaining apparatus of claim 1, wherein the clamp member slides vertically and stays in position under frictional engagement within the sleeve.

14. The adjustable bag retaining apparatus of claim 2, wherein the clamp member is attached at the distal end of a sleeve engaging member for sliding vertically within the sleeve.

15. The adjustable bag retaining apparatus of claim 1, wherein the sleeve comprises one or more protrusions extending into the cavity of the sleeve, and said sleeve engaging member comprises one or more stopping members to abut said one or more protrusions on said sleeve to prevent removal or disassembly of the sleeve engaging member from said sleeve.

16. The adjustable bag retaining apparatus of claim 1, wherein the clamp member comprises a torsion spring that biases the clamp member to closed or clamping position.

17. The adjustable bag retaining apparatus of claim 2, further comprising at least two extension members positioned about opposite sides of the support frame and extending outwardly therefrom and generally parallel to the base member and comprise a terminal end portion that curves upward away from the base member.

18. The adjustable bag retaining apparatus as defined in any of FIGS. 1-22 or any combination of features shown therein.

19. An adjustable bag holding apparatus comprising the adjustable bag retaining apparatus of claim 1, wherein the clamp member is replaced by a hook member.

20. An adjustable bag retaining apparatus comprising a clamp member or hook member, said clamp or hook member capable of being adjusted to a desired vertical height on a stand, track, mast or support by a height adjustment means.
